(19) United States
(12) Patent Application Publication
(10) Pub. No.: US 2003/0210911 A1
(43) Pub. Date: Nov. 13, 2003

(54) Dispersion compensator and dispersion compensating system

(75) Inventors: Koichi Takahashi, Hachioji-shi (JP); Kenji Ichimura, Fuchu-shi (JP)

Correspondence Address: John C. Altmiller, Kenyon & Kenyon, Suite 700, 1500 K Street,N.W., Washington, DC, 20005-1257, US

(73) Assignee: OLYMPUS OPTICAL CO., LTD., Tokyo (JP)

(21) Appl. No.: 10/430,408

(22) Filed: May 7, 2003

(30) Foreign Application Priority Data
May 9, 2002 (JP) 2002-134633

(51) Int. Cl. H04B 10/12

(52) U.S. Cl. 398/147

(57) ABSTRACT

A dispersion compensator comprising an angular dispersive element that varies the angle at which the light, emitted from the optical transmission element through which it is transmitted, is output depending on its wavelength; an optical element that condenses the light emitted from the angular dispersive element; an optical deflector that deflects the light emitted from the optical element; and a reflecting mirror that is disposed in proximity to the focal point position in the optical system and that has a reflecting surface whose shape along the direction perpendicular to the plane on which the light is deflected changes at least in the direction along the plane on which the light is deflected.

### BACKGROUND OF THE INVENTION

1. Field of the Invention

The present invention relates to a dispersion compensator and a dispersion compensating system that compensates degradation of an optical signal due to wavelength dispersion that occurs during transmission through an optical element such as an optical fiber used in optical communication.

This specification is based on patent application number 2002-134633 filed in Japan, the contents of which are incorporated herein by reference.

### DESCRIPTION OF THE RELATED ART

Conventionally, the type of dispersion compensator disclosed, for example, in Published Japanese Translation No. 2000-511655 of the PCT International Application is known.

This dispersion compensator collimates and condenses light emitted from an optical fiber, and then passes it through a VIPA (virtual image phase array) disposed at the focal point position thereof. Subsequently, the light output from the VIPA is condensed again, reflected by a reflecting mirror disposed at the focal point position thereof, and returned to the optical fiber by passing through the entire route in reverse. When viewed from the side, a planar mirror having a planar surface, a concave mirror having a concave surface, or a convex mirror having a convex surface can be selected as the reflecting mirror.

In the conventional dispersion compensator structured in this manner, the light that has been transmitted through the optical fiber is condensed and then passed through a VIPA. The VIPA has an approximately 100% reflecting surface and an approximately 98% reflecting surface which are disposed facing each other. The incident light undergoes multiple reflection between these surfaces to produce self-interference. Thereby, a spatially distinguishable light beam of each wavelength can be generated and output. Therefore, by condensing the light output from the VIPA at different points on the reflecting mirrors and varying the shape of the reflecting mirrors, optical path differences are established between each wavelength, and thereby the wavelength dispersion can be compensated.

In addition, a method has also been proposed wherein a reflecting mirror having a free-form surface is moved using a movable stage causing the light to be reflected at a position that allows attaining the desired dispersion value.

### SUMMARY OF THE INVENTION

The present invention provides a dispersion compensator that comprises an angular dispersive element that varies the angle at which the light, emitted from an optical transmission element through which the light is transmitted, is output depending on the wavelength of the light; an optical element that condenses the light emitted from the angular dispersive element; an optical deflector that deflects the light emitted from the optical element; and a reflecting mirror that is disposed in proximity to the focal point position in an entire optical system and that has a reflecting surface whose shape along the direction perpendicular to the plane on which the light is deflected changes at least in the direction along the plane on which the light is deflected.

In addition, the present invention provides a dispersion compensator that comprises angular dispersive means for varying the angle at which the light, emitted from optical transmission means through which the light is transmitted, is output depending on the wavelength of the light; condensing means for condensing the light emitted from the angular dispersion means; optical deflecting means for deflecting the light emitted from the condensing means; and reflecting means being disposed in proximity to the focal point position in an entire optical system and having a reflecting surface whose shape along the direction perpendicular to the plane on which the light is deflected changes at least in the direction along the plane on which the light is deflected.

In addition, the present invention provides a dispersion compensation method comprising the steps of: varying the angle of emission of the light depending on the wavelength of the light transmitted through an optical transmission element and emitting the light whose angle of emission has been varied, condensing the emitted light, deflecting the condensed light; and imparting optical path lengths that differ according to the reflection position in the direction perpendicular to the plane on which the condensed light is deflected in proximity to the focal point position of the deflected light, and reflecting the light to which different optical path lengths have been imparted.

### BRIEF DESCRIPTION OF THE DRAWINGS

FIG. 1A and FIG. 1B are drawings showing the structure of the dispersion compensator according to a first embodiment of this invention.

FIG. 2 shows a cross-sectional drawing showing a cross-section along A-A in FIG. 1A.

FIG. 3 shows a cross-sectional drawing showing a cross-section along B-B in FIG. 1A.

FIG. 4A through FIG. 4C are optical path diagrams showing the optical path of examples of numerical embodiments of an optical system that forms the dispersion compensator in FIG. 1A and FIG. 1B.

FIG. 5 is a cross-sectional drawing showing another example of the cross-sectional shape of the reflecting mirror of the dispersion compensator in FIG. 1A and FIG. 1B.

FIG. 6A and FIG. 6B are drawings showing the structure when an angular dispersive element of the dispersion compensator in FIG. 1A and FIG. 1B is replaced by a prism.

FIG. 7A and FIG. 7B are drawings showing the structure when the angular dispersive element of the dispersion compensator in FIG. 1A and FIG. 1B is replaced by an interferometer or an etalon.

FIG. 8 is a drawing showing a part of the structure of the dispersion compensator according to a second embodiment of this invention.

FIG. 9 is a drawing showing a part of the structure of the dispersion compensator when a rotating mirror and a positive lens in FIG. 8 are replaced by a polygonal mirror and an fθ lens, respectively.

FIG. 10A and FIG. 10B are drawings showing the structure of the dispersion compensator according to a third embodiment of this invention.

FIG. 11 is a block diagram showing the dispersion compensating system according to the embodiments of this invention.

### DETAILED DESCRIPTION OF THE PREFERRED EMBODIMENTS

Below, the dispersion compensator according to a first embodiment of this invention will be explained with reference to the drawings.

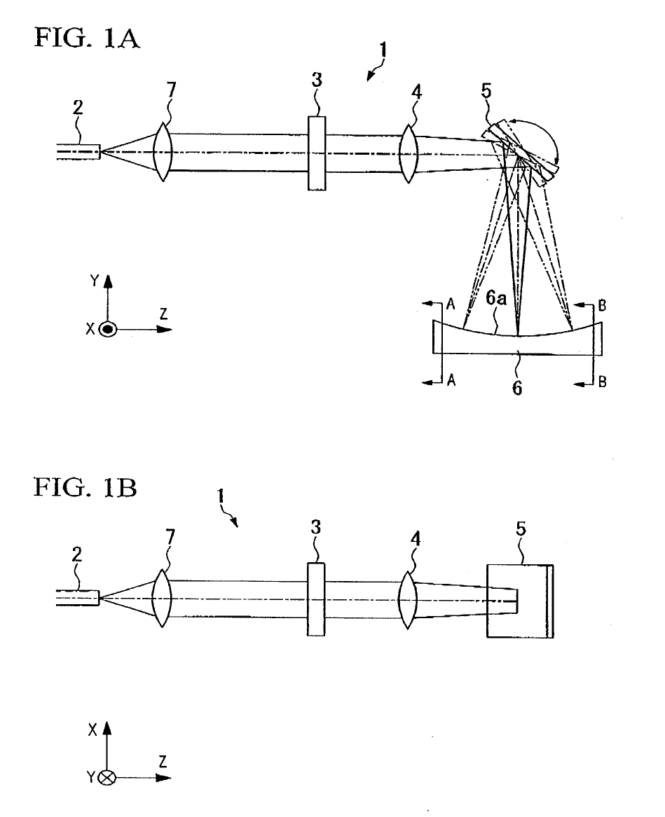

The dispersion compensator 1 according to the present embodiment comprises a diffraction gating (angular dispersive element) 3, a focusing lens (condensation device) 4, a rotating mirror (optical deflector) 5, and a reflecting mirror (omitted from FIG. 1B) 6. The light emitted from the end of the optical fiber 2 is incident on the diffraction grating 3, and each wavelength of the light is output at a different angle. The focusing lens 4 condenses the light output by the diffraction grating 3. The rotating mirror 5 is disposed at a position along the path of the condensation by the focusing lens 4, and reflects and deflects the light. The reflecting mirror 6 has a reflecting surface 6a disposed in proximity to the focal point position of this light. In the figures, reference numeral 7 is a collimating lens that makes the light emitted from the end of the optical fiber 2 substantially parallel.

The XYZ coordinate system shown in the figures is a rectangular coordinate system in which the Z axis is disposed from left to right along the surface of the drawing and positive to the right. FIG. 1A shows the Y-Z plane and FIG. 1B shows the X-Z plane. Note that for all the drawings when the X-axis and the Y-axis are interchanged, the only difference is whether the dispersion compensator of the present invention is disposed longitudinally or transversely, and this does not related to the essence of the present invention. In addition, in all of the figures, the illustrated light paths are shown after extracting only the light of a particular wavelength.

The diffraction grating 3 is a one-dimensional diffraction grating 3, and grating grooves (not illustrated) are formed in the Y-direction so that angular dispersion is generated in the X-direction shown in FIG. 1B.

The rotating mirror 5 can rotate around the center of rotation disposed along the X-axis at the reflection point of the light in the direction of the arrow shown in FIG. 1A. Thereby, the rotating mirror 5 can deflect the light in the Y-Z plane. In the present embodiment, the Y-Z plane can also be referred to as the plane on which the light is deflected. In addition, the X-direction perpendicular to this Y-Z plane can also be referred to as the direction perpendicular to the plane on which the light is deflected.

In addition, the rotating mirror 5 can rotate by oscillating centered on the position that forms a 45° angle in the Y-Z plane with respect to the optical axis of the light output from the diffraction grating 3. Furthermore, the rotating mirror 5 rotates the optical axis 90° from the diffraction grating 3 towards the reflecting mirror 6.

The reflecting surface 6a of the reflecting mirror 6 is, for example, a free-form surface mirror.

The free-form surface used in the present embodiment is represented, for example, by the following equation. Note that the Z-axis in this equation is the axis of the free-form surface:

$$z = \frac{c {r}^{2}}{1 + \sqrt{1 - ( 1 + k ) {c}^{2} {r}^{2}}} + {\sum }_{j = 2}^{66} {C}_{j} {X}^{m} {Y}^{n} \qquad ( 1 )$$

where the first term in equation 1 is the spherical surface term and the second term is the free-form surface term. In addition, in the spherical surface term, c is the curvature at the vertex, k is a conic constant, and r=√(X²+Y²).

The free-form surface term can be expanded as in the following equations 2:

$$\begin{matrix}{\sum }_{j = 2}^{66} {C}_{j} {X}^{m} {Y}^{n} = {C}_{2} X + {C}_{3} Y + \\ {C}_{4} {X}^{2} + {C}_{5} X Y + {C}_{6} {Y}^{2} + \\ {C}_{7} {X}^{3} + {C}_{8} {X}^{2} Y + {C}_{9} X {Y}^{2} + {C}_{10} {Y}^{3} + \\ {C}_{11} {X}^{4} + {C}_{12} {X}^{3} Y + {C}_{13} {X }^{2} {Y}^{2} + {C}_{14} X {Y}^{3} + {C}_{15} {Y}^{4} + \\ {C}_{16} {X}^{5} + {C}_{17} {X}^{4} Y + {C}_{18} {X }^{3} {Y}^{2} + {C}_{19} {X}^{2} {Y}^{3} + {C}_{20} X {Y}^{4} + {C}_{21} {Y}^{5} + \\ {C}_{22} {X}^{6} + {C}_{23} {X}^{5} Y + {C}_{24} {X }^{4} {Y}^{2} + {C}_{25} {X}^{3} {Y}^{3} + {C}_{26} {X }^{2} {Y}^{4} + {C}_{27} X {Y}^{5} + {C}_{28} {Y}^{6} + \\ {C}_{29} {X}^{7} + {C}_{30} {X}^{6} Y + {C}_{31} {X }^{5} {Y}^{2} + {C}_{32} {X}^{4} {Y}^{3} + {C}_{33} {X }^{3} {Y}^{4} + {C}_{34} {X}^{2} {Y}^{5} + {C}_{35} X {Y}^{6} + {C}_{36} {Y}^{7} + …\end{matrix} \qquad ( 2 )$$

where Cⱼ (j is an integer equal to or greater than 2) is a coefficient.

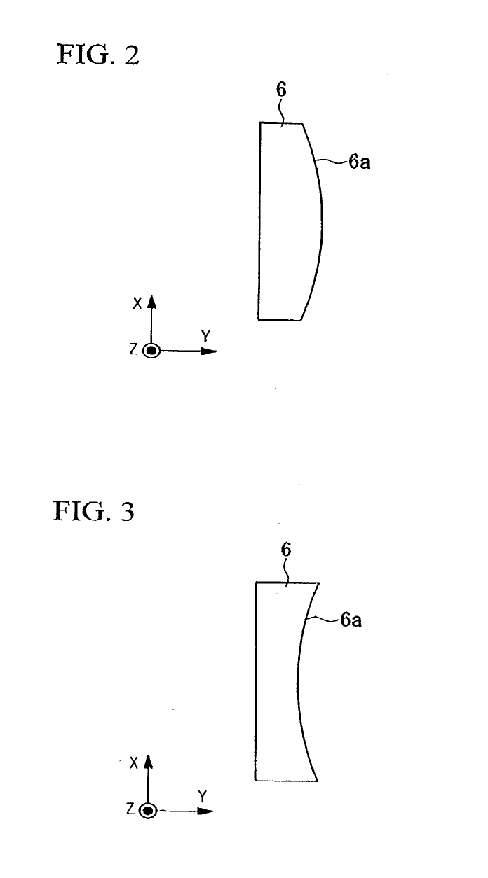

Specifically, in the A-A cross-section in FIG. 1A, the reflecting surface 6a of the reflecting mirror 6 has a convex shape such as that shown in FIG. 2, and in the B-B cross-section in FIG. 1A has a concave shape such as that shown in FIG. 3. In addition, in the part of the reflecting surface 6a outside of the A-A cross-section and the B-B cross-section, the cross-sectional shape in the Z direction comprises a free-form surface that changes continuously from the concave shape and a convex shape.

The cross-sectional shapes along the X-Y plane in the reflecting surface 6a of the reflecting mirror 6 impart differences in the optical path lengths with respect to the light reflected at different positions in the X-direction. At different positions in the X-direction on the reflecting surface 6a, the differences in optical path length imparted to the reflected light are determined by the amount of the wavelength dispersion that occurs in the transmitted light. Therefore, by disposing the focal point positions of the light on this reflecting surface 6a at predetermined positions in the Z-direction determined by the amount of wavelength dispersion, it becomes possible to impart differences in optical path length to the light so as to allow suitable compensation of the amount of wavelength dispersion.

In addition, as shown in FIG. 1A, in the Y-Z plane, the reflecting surface 6a of the reflecting mirror 6 has an arc shape centered on the center of rotation of the rotating mirror 5. Specifically, in the Y-Z direction, where R denotes the distance from the center of rotation of the rotating mirror 5 to the reflecting surface 6a of the reflecting mirror 6, the reflecting surface 6a of the reflecting mirror 6 forms an arc shape having a radius of curvature R. In addition, the reflecting surface 6a of the reflecting mirror 6 is distributed over a predetermined length range in the Z-direction centered on the optical axis that has been rotated 90° by the rotating mirror 5.

The operation of the dispersion compensator 1 according to the embodiment structured in this manner will now be explained.

Wavelength dispersion occurs in an optical signal transmitted through an optical fiber 2 over a long distance, and due to this, a group delay occurs. After the light emitted from the end of the optical fiber 2 is made substantially parallel by passing though the collimating lens 7, it is incident on the diffraction grating 3. At the diffraction grating 3, because the diffraction grooves are formed along the Y-direction, the angle of emission in the X-direction of the light incident on the diffraction grating 3 differs depending on the wavelength, and is output from the diffraction grating 3 as light distributed in the X-axis direction.

The light output from the diffraction grating 3 becomes convergent light due to passing through the focusing lens 4, and is incident on the rotating mirror 5 in front of the focal point. Because the rotating mirror 5 is tilted approximately 45° with respect to the incident optical axis in the Y-Z plane, the light incident on the reflection point at the center of rotation is deflected 90°, and thereby becomes oriented in the Y-direction. In addition, because the reflecting mirror 6 is disposed in proximity to the focal point position formed at a position separated from the rotating mirror 5 in the Y-direction, the light is reflected at the reflecting surface 6a of the reflecting mirror 6.

In this case, according to the dispersion compensator 1 of the present embodiment, in the Y-Z direction, the reflecting surface 6a of the reflecting mirror 6 forms an arc shape centered on the center of rotation of the rotating mirror 5, that is, centered on the reflection point of the light in the rotating mirror 5. Thus, the angle of incidence of the light on the reflecting mirror 6 becomes 0° irrespective of the deflection angle of the light due to the rotating mirror 5. Therefore, the light reflected in the reflecting mirror 6 returns to the optical fiber 2 by following the same optical path in the reverse direction, transiting the reflecting mirror 6, the rotating mirror 5, the focusing lens 4, the diffraction grating 3, to the collimating lens 7. In addition, the angle of incidence at the reflecting mirror 6 is 0°, and thus the loss of light in the reflecting mirror 6 can be reduced to a minimum.

In addition, the reflecting surface 6a of the reflecting mirror 6 has a cross-sectional shape along the X-direction comprising a surface that rolls from a valley (a concave surface) to a ridge (a convex surface) in the Y-direction. Thereby, the light incident on the reflecting surface 6a distributed along the X-direction has imparted optical path lengths that differ depending on the reflection position on this reflecting surface 6a in the X-direction. The light made incident on the reflecting mirror 6 has differing angles of emission in the X-direction for each wavelength due to the diffraction grating 3, and thus the position of incidence on the reflecting mirror 6 in the X-direction is determined according to the wavelength of the light. Therefore, the optical path length of the light having slower traveling wavelengths will be short while the optical path length of the light having faster traveling wavelengths will be long, and thus the arrival time of each wavelength can be adjusted and the group delay caused by wavelength dispersion can be eliminated.

Furthermore, according to the dispersion compensator 1 of the present embodiment, by rotating the rotating mirror 5, the deflection angle of the light is varied, and it is possible to vary the Z-direction position of the reflection point on the reflecting mirror 6 that condenses the light. The reflecting surface 6a of the reflecting mirror 6 has a free-form surface shape in which the cross-sectional shape varies continuously in the X-Y plane in the Z-direction. Thereby, the position of the reflection point having a cross-sectional shape that allows compensation of the wavelength dispersion can be selected simply by varying the angle of the rotating mirror 5.

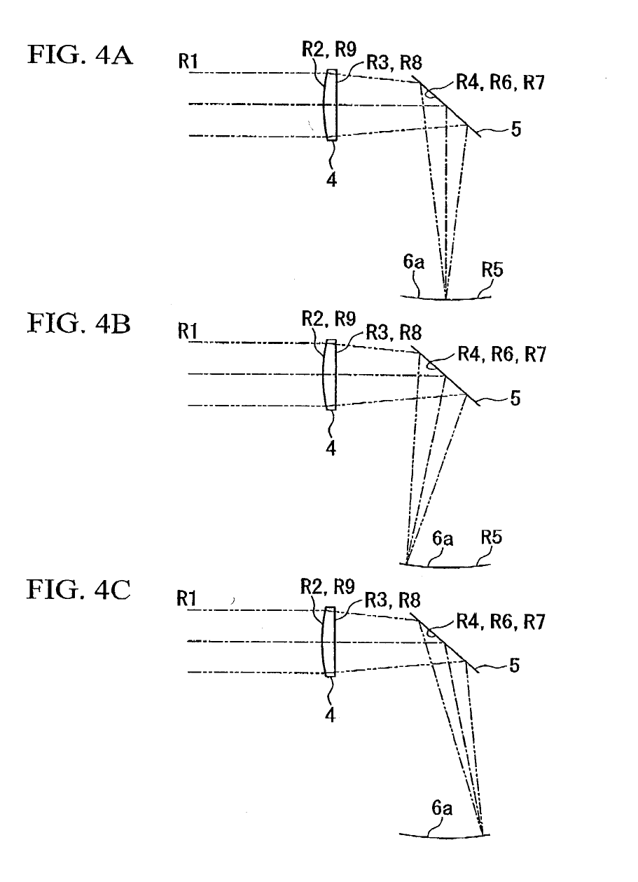

Next, an example of the design of the optical system using the dispersion compensator 1 according to the present embodiment will be explained with reference to FIG. 4A, FIG. 4B, and FIG. 4C. In the figures, numbers starting with “R” denote the surface number in the following numerical value embodiment.

FIG. 4A, FIG. 4B, and FIG. 4C are optical path diagrams showing the optical path in the numerical value embodiment of the optical system shown below after being output from the diffraction grating 3 in the optical system that forms the dispersion compensator 1 according to the present embodiment. FIG. 4A is the case in which the angle α of the rotating mirror 5 is 45°, FIG. 4B is the case in which the angle α is 40°, and FIG. 4C is the case in which the angle α is 50°.

Below, a numerical value embodiment of the optical system in the above design example is shown. Here, α, β, and γ denoting the eccentricity are viewed in the positive direction of the X, Y, and Z axes, and show the angle taken in the counter-clockwise direction centered on these axes. The unit of length is millimeters (mm), and the unit of the angle is degrees (°). For example, the deflection angle of the rotating mirror 5 is shown by the amount of eccentricity of the surface number 4, and this is shown disposed at the position where α=45°. In addition, the refractive index is shown for a wavelength of 587.56 nm.

| surface | radius of | surface | | refractive | Abbe |
|---|---|---|---|---|---|
| number | curvature | distance | eccentricity | index | Number |
| object | ∞ | ∞ | | | |
| surface | | | | | |
| 1 | ∞ | 25.00 | | | |
| 2 | 40.00 | 3.00 | 1.5163 | 64.1 | |
| 3 | ∞ | 25.00 | | | |
| 4 | stop surface | 0.00 | eccentricity(1) | | |
| 5 | 49.61 | 0.00 | eccentricity(2) | | |
| 6 | | 0.00 | eccentricity(1) | | |
| 7 | 03 | 0.00 | | | |
| 8 | ∞ | −3.00 | eccentricity(3) | 1.5163 | 64.1 |
| 9 | 40.00 | −25.00 | | | |
| image | ∞ | 0.00 | | | |
| surface | | | | | |

eccentricity[1]

| | | | | | |
|---|---|---|---|---|---|
| X | 0.00 | Y | 0.00 | Z | 0.00 |
| α | 45.00 | β | 0.00 | γ | 0.00 |

eccentricity[2]

| | | | | | |
|---|---|---|---|---|---|
| X | 0.00 | Y | −49.61 | Z | 0.00 |
| α | 90.00 | β | 0.00 | γ | 0.00 |

eccentricity[3]

| | | | | | |
|---|---|---|---|---|---|
| x | 0.00 | y | 0.00 | z | −25.00 |
| α | 0.00 | β | 0.00 | γ | 0.00 |

Thus, according to the dispersion compensator 1 of the present embodiment, a reflecting mirror 6 that requires a large installation space is made stationary, and simply by varying the deflection angle of the comparatively small rotating mirror 5, it is possible to compensation the wavelength dispersion. Therefore, it is not necessary to provide a space in which the reflecting mirror 6 can move, and thereby it is possible to down-size the apparatus. In addition, because the light emitted from the focusing lens 4 is rotated by the rotating mirror 5, the total length of the apparatus can be made short, and thereby it is possible to implement down-sizing. In addition, because the comparatively light rotating mirror 5 is moved instead of the heavy reflecting minor 6, the positioning precision of the drive apparatus can be improved simply, and in addition, it is possible to decrease the energy consumption required to drive the apparatus. Therefore, it is possible to realize reductions in both the product cost and the operating cost.

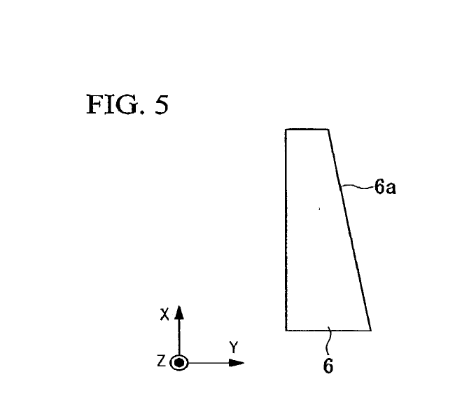

Note that in the present embodiment, the reflecting surface 6a of the reflecting mirror 6 is formed having the free-form surface represented by equation 1. However, in uses that do not require extremely high precision dispersion compensation, instead of this, it is possible to use the reflecting surface 6a having a slanted surface shape that inclines in the X-Y plane along the X-direction as shown in FIG. 5. In addition, the cross-sectional shapes of the reflecting mirrors 6 shown in FIG. 2 and FIG. 3 can also have an arc shape.

In addition, an example was explained wherein the shape of the reflecting surface 6a has a free-form surface that varies continuously in the Z-direction, but a structure is possible wherein the free-form surface varies discontinuously or stepwise in the Z-direction.

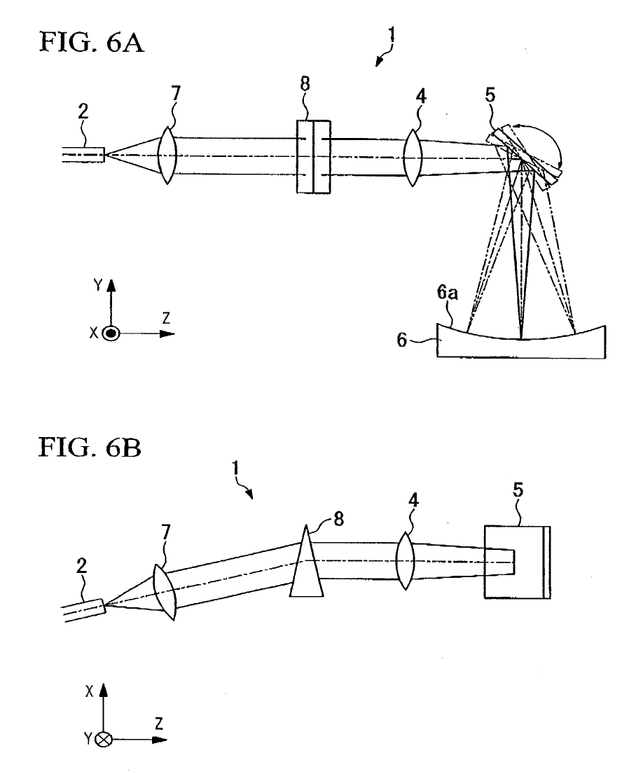

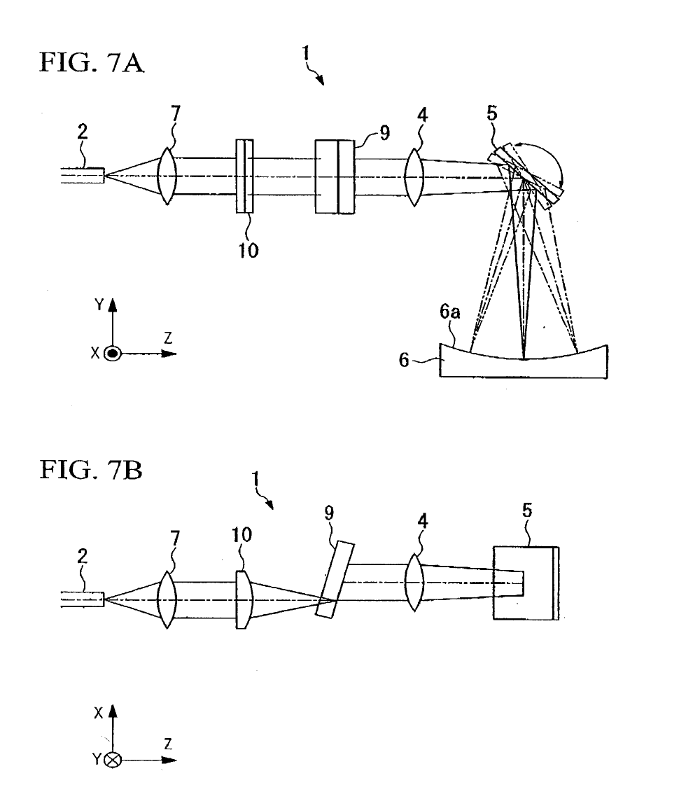

In addition, in the present embodiment, a diffraction grating 3 was used as an angular dispersive element, but instead of this, the prism 8 shown in FIG. 6A and FIG. 6B can be used. In addition, as shown in FIG. 7A and FIG. 7B, it is also possible to use an interferometer such as a Fabry-Pérot interferometer or a Fabry-Pérot etalon 9 as the angular dispersive element. In this case, it is necessary to condense the incident light on the angular dispersive element in the X-direction, and a condensing lens 10 such as a cylindrical lens is disposed between the collimating lens 7 and the angular dispersive element 9.

In particular, using a Fabry-Pérot interferometer or a Fabry-Pérot etalon is preferable because it is possible to obtain large angular dispersion.

In addition, in the present embodiment, the reflecting surface 6a of the reflecting mirror 6 in the Y-Z plane is formed in an arc shape centered on the center of rotation of the rotating mirror 5. Thereby, the loss of the optical signal is reduced to a minimum, but in uses in which a certain degree of loss can be tolerated, it is possible to use shapes other than an arc shape. In this case, the angle of incidence of the light on the reflecting surface 6a of the reflecting mirror 6 must be as near as possible to the 0° domain. Being incident on an angle −5° or greater and +5° or less is satisfactory, −3° to +3° is preferable, and −1° to +1° is most preferable.

In addition, in the present embodiment, the reflecting surface 6a of the reflecting mirror 6 in the Y-Z plane is formed in an arc shape centered on the center of rotation of the rotating mirror 5. However, instead of this, a shape that is axisymmetric in the Z-direction in the Y-Z plane can be used in the case that the deflection angle of the rotating mirror 5 is 45°, where the incident optical axis on the reflecting surface 6a of the reflecting mirror 6 serves as the reference.

In addition, the light transmitted through the optical fiber 2 is preferably light in the 1.2 to 1.7 μm wavelength band. Thereby, because the absorption in the optical fiber 2 is suppressed, compensation of the wavelength dispersion can be carried out using a high intensity optical signal.

Next, a dispersion compensator according to a second embodiment of the present invention will now be explained. Note that in the explanation of the dispersion compensator according to the present embodiment, identical reference numerals are applied to parts that are common to the structure of the dispersion compensator according to the first embodiment described above, and thus their explanation has been omitted.

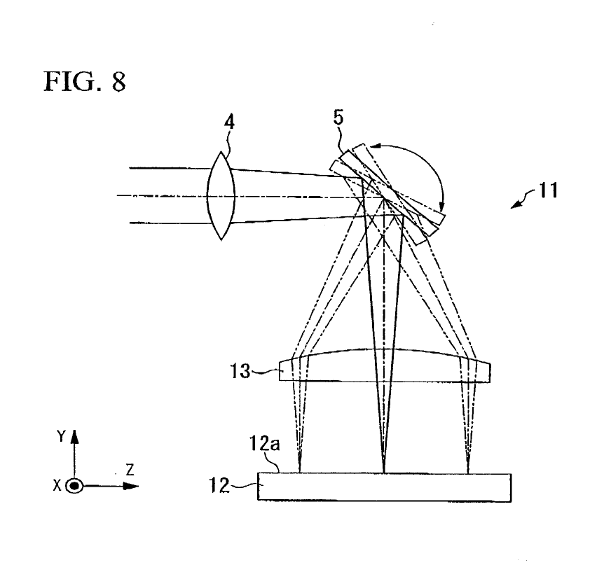

As shown in FIG. 8, the dispersion compensator 11 according to this embodiment differs from the dispersion compensator 1 according to the first embodiment in providing a positive lens 13 between the rotating mirror 5 and the reflecting mirror 12, and in the shape of the reflecting mirror 12.

The positive lens 13 is an image-side telecentric lens having a positive power.

In addition, the reflecting mirror 12 is formed having a linear shape in the Y-Z plane. The cross-section in the direction of the X-Y plane is identical to that shown in FIG. 2 and FIG. 3. In addition, these cross-sectional shapes vary continuously in the Z-direction. The operation of the dispersion compensator 11 according to the present embodiment formed in this manner will now be explained.

In the dispersion compensator 11 according to this embodiment, the light emitted from the focusing lens 4 is reflected in a direction depending on the angle of the rotating mirror 5, and thus is deflected in the Y-Z plane and oriented towards the positive lens 13.

The positive lens 13 has a positive power, and thus the light that is incident on the positive lens 13 is refracted so as to converge. In addition, the positive lens 13 is an image-side telecentric lens, and thus the light emitted from the positive lens 13 is made parallel and then incident on the reflecting surface 12a of the reflecting mirror 12 at an angle of incidence of approximately 0°. Therefore, even when a planar reflecting mirror 12 is used in the Y-Z plane, it is possible to suppress the occurrence of curvature of field in the reflecting mirror 12.

In this manner, in the dispersion compensator 11 according to this embodiment, an image-side telecentric positive lens 13 is disposed between the rotating mirror 5 and the reflecting mirror 12, and thereby it is possible to make the shape of the reflecting mirror 12 in the Y-Z plane have a flat shape. Therefore, it is possible to manufacture the reflecting mirror 12 easily. In addition, by disposing a positive lens 13 having a positive power between the rotating mirror 5 and the reflecting mirror 12, it is possible to compensate simultaneously the curvature of field that occurs due to the reflection in the rotating mirror 5.

Note that in the present embodiment, a rotating mirror 5 that rotates centered on the reflection point is used as the optical deflector that deflects the light emitted from the focusing lens 4. Thus, an arcsine lens is preferably used as the positive lens 13. Thereby, because the position of the reflection point on the reflecting surface 12a of the reflecting mirror 12 has a proportional relationship to the arcsine of the angle of the rotating mirror 5, it is possible to determine the focal point position on the reflecting surface 12a of the reflecting mirror 12 simply according to the angle of the rotating mirror 5. Therefore, the focal point position of the reflecting mirror 5, that is, the cross-sectional shape in the X-Y plane, can be selected easily.

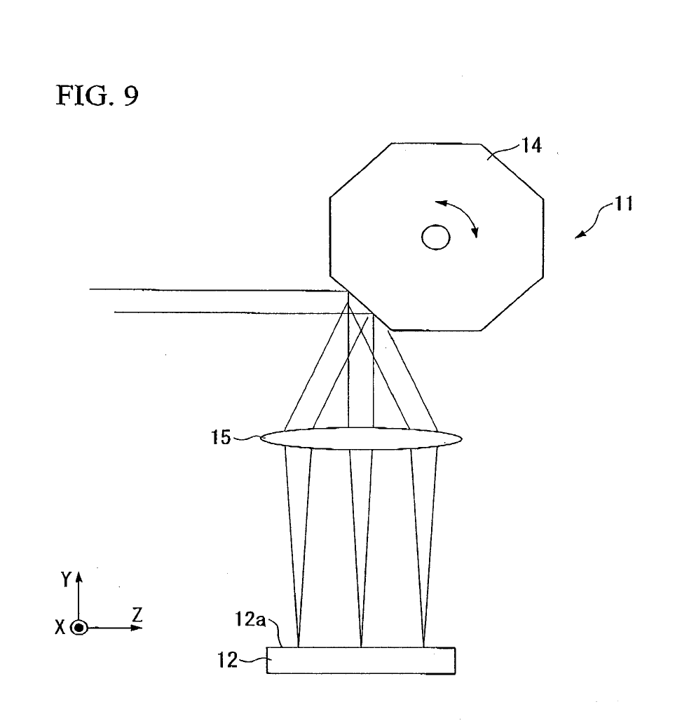

In addition, as shown in FIG. 9, in the case of using a polygonal mirror 14 that rotates centered on a center of rotation separated by a predetermined distance from the reflection point, an fθ lens 15 is used as the positive lens 13. Thereby, because the position of the reflection point on the reflecting surface 12a of the reflecting mirror 12 has a proportional relationship with the angle of the polygonal mirror 14, it is possible to obtain effects identical to those described above.

Note that it is possible to replace the positive lens 13 with a cylindrical lens. This case can be realized by replacing the focusing lens 4 by a cylindrical lens that has power only in the direction perpendicular to the direction that establishes the positive power of the replacing cylindrical lens and has a focal point at the same position as the focal point position of the cylindrical lens that replaces the positive lens 13.

Next, the dispersion compensator according to a third embodiment of this invention will now be explained with reference to the figures.

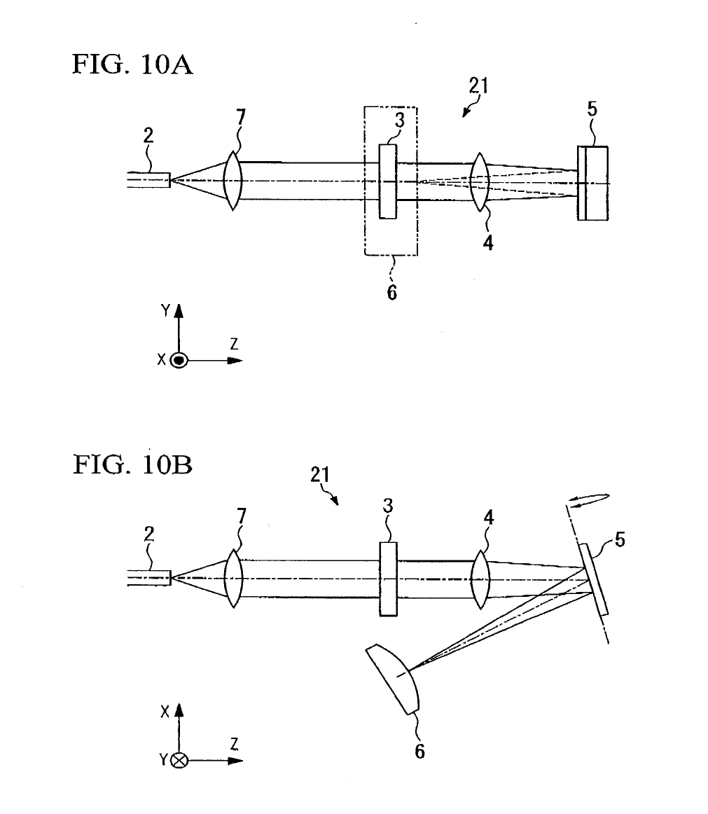

The dispersion compensator 21 of this embodiment differs from the dispersion compensators 1 and 11 in each of the embodiments described above in the direction of inclination of the rotating mirror 5, as shown in FIG. 10A and FIG. 10B.

The rotating mirror 5 of the dispersion compensator 1 and 11 according to the first and second embodiments was inclined in the Y-Z plane approximately 45° with respect to the incident optical axis. As shown in FIG. 10A, in contrast, in the dispersion compensator 21 the central angle of inclination is 0° in the Y-Z plane, and in addition, as shown in FIG. 10B, the inclination angle in the X-Z direction is set to approximately 30° or less. Note that this inclination angle can be an angle such that the reflecting mirror 6 disposed at the focal point position of the light reflected in the rotating mirror 5 is disposed at a position that does not interfere with the path of the light incident on the rotating mirror 5.

According to the dispersion compensator 21 in this embodiment structured in this manner, the light emitted from the focusing lens 4 is made incident on the rotating mirror 5 at an angle of incidence of approximately 0°. Because the reflectance of the rotating mirror 5 is highest when the angle of incidence is 0°, the loss of the optical signal reflected at the rotating mirror 5 can be deceased.

Next, the dispersion compensating system 31 according to the embodiment of this invention will be explained with reference to the figures.

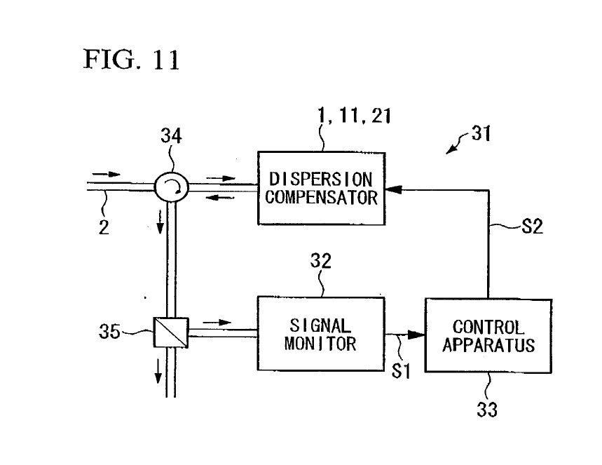

As shown in FIG. 11, the dispersion compensating system 31 according to the present embodiment comprises any of the dispersion compensators 1, 11, or 21 described above, a signal monitor 32, and a control apparatus 33. The signal monitor 32 monitors the light output from the dispersion compensators 1, 11, or 21. The control apparatus 33 controls the deflection angle of the rotating mirror 5 based on the output from the signal monitor 32. In the figures, reference numeral 34 is a circulator that separates the light transmitted through the optical fiber 2 and the light returning from the dispersion compensators 1, 11, or 21, and extracts the light returning from the dispersion compensators 1, 11, or 21. In addition, reference numeral 35 is a spectroscope that extracts a part of the dispersion compensated light output from the circulator 34.

The signal monitor 32 inputs the dispersion compensated light output from the dispersion compensators 1, 11, or 21, and extracts a signal S1 that includes dispersion data such as the amount of wavelength dispersion by analyzing the light.

The control apparatus 33 outputs a move command signal S2 to the rotating mirror 5 so as to compensate the wavelength dispersion based on the signal S1 that includes the dispersion data output from the signal monitor 32.

According to the dispersion compensating system 31 of this embodiment structured in this manner, by activating the dispersion compensators 1, 11, or 21, when the wavelength dispersion of the light transmitted through the optical fiber 2 is compensated, the amount of wavelength dispersion becomes zero. Therefore, because the move command signal S2 from the control apparatus 33 to the rotating mirror 5 becomes zero, the rotating mirror 5 inside the dispersion compensators 1, 11, or 21 is maintained in the current deflection state. That is, in the case that the wavelength dispersion of the light transmitted through the optical fiber 2 is constantly generated, it is maintained in that state once the compensation has completed.

However, in the case that the environment in which the optical fiber 2 is disposed, including for example temperature and vibration, or the frequency band of the optical signal transmitted through the optical fiber 2 vary, the amount of wavelength dispersion included in the optical signal also varies. In such a case, a signal S1 that includes dispersion data indicating how much wavelength dispersion has newly occurred in the optical signals which are output by the dispersion compensators 1, 11, or 21 and whose wavelength dispersion has been compensated is output from the signal monitor 32. In addition, the control apparatus 33 carries out control such that the rotating mirror 5 is rotated by an amount equivalent to an angle depending on this signal S1. Specifically, simply by associating in advance the rotation angle of the rotating mirror 5 and the amount of the dispersion compensation according to the shape of the reflecting surface 6a of the reflecting mirror 6 selected at that time, automatic adjustment can be carried out such that the amount of wavelength dispersion is always suppressed to a minimum.

In this manner, according to the dispersion compensating system 31 of this embodiment, automatic adjustment is carried out such that the amount of the wavelength dispersion becomes minimal. Therefore, the effect is attained that the optical signal loss can be suppressed even if, in the future, the transmission speed of optical signals increases and thus the wavelength dispersion fluctuates more readily due to external factors such as temperature or vibration.

As explained above, according to the dispersion compensator of each of the embodiments described above, the occupied space is decreased by making the number of moving components small and rotating the light path. Thereby, the effect is attained that it becomes possible to make down-sized and light-weight designs while suppressing loss and carry out high precision compensation at the same time.

Specifically, while the light that has been dispersed at an angle determined for each wavelength is condensed by the optical element by passing through the angular dispersive element, it is deflected by the optical deflector, and then condensed and reflected on the reflecting mirror. The light reflected at the reflecting mirror returns to the optical transmission element by following the path in reverse. Because the light is dispersed by the angular dispersive element at angles that differ for each wavelength, each wavelength arrives at a different position on the reflecting mirror and is then reflected. In addition, the reflecting surface of the reflecting mirror is formed in a predetermined shape along the direction perpendicular to the plane on which the light is deflected, and thus it is possible to impart optical path lengths that differ for light of different wavelengths, and it is possible to compensate the wavelength dispersion.

In this case, the shape of the reflecting surface of the reflecting mirror described above along the direction perpendicular to the plane on which the light is deflected varies along the plane on which the light is deflected. Therefore, simply by varying the deflection angle of the light by adjusting the angle of the optical deflector, it is possible to select an incidence position on the reflecting mirror appropriate for compensating the wavelength dispersion. Specifically, it is possible to compensate the wavelength dispersion appropriately depending on the optical transmission element by using only the rotation of the optical deflector, which is a comparatively small essential constituent, without having to move the reflecting mirror. Thereby, downsizing of the apparatus becomes possible. In addition, because the optical path reverses back on itself due to the light being deflected by the optical deflector, it is possible to reduce the overall length of the apparatus.

In the case that all angles of incidence with respect to the reflecting mirror of light deflected by the optical deflector are within a range equal to or greater than −5° and equal to or less than +5°, it is possible to suppress the loss of light when being reflected in the reflecting mirror, and thus it is possible to prevent degradation of the optical signal.

In the case that the direction of deflection by the optical deflector is perpendicular to the direction in which each wavelength is dispersed by the angular dispersive element, the focal point position of the light that has been dispersed according to each wavelength by the angular dispersive element is moved in the direction perpendicular to this dispersion direction by the action of the optical deflector. Therefore, by preparing a reflecting surface having a shape that differs in the direction of the movement of this focal point position, it is possible to condense the light on a reflecting surface suitable for compensating the wavelength dispersion of this light simply by activating the optical deflector, and thereby it is possible to compensate this wavelength dispersion appropriately.

In the case of forming the reflecting surface of the reflecting mirror using a free-form surface having a shape that is asymmetrical with respect to the optical axis, the light is reflected at different positions on the reflecting surface of the reflecting mirror when changing the direction of the deflection of the light. However, because the reflecting surface is formed asymmetrically with respect to the optical axis, it is possible for the light to reflect on the reflecting surface that has a different shape for each deflection direction. In this case, by forming the reflecting surface using a free-form surface, a curved surface is formed that conforms to changes in the amount of compensated dispersion, and thereby higher precision dispersion compensation becomes possible.

Here, free-form surface is represented by, for example, equation 1 and equation 2 given above. Generally, because the optical system is represented using a right-handed rectangular coordinate system with the Z-axis serving as the optical axis, even after being reflected by the mirror, the optical axis after reflection is transformed as the Z axis. Therefore, the optical axis serves as the reference for the Z-axis in equation 1 and equation 2.

However, in the explanation related to the figures in each of the embodiments described above, for the sake of convenience, even after deflection by the optical deflector, the coordinate axes disclosed in the figures before transformation is used.

In the case that the reflecting surface of the reflecting mirror has a concave shape at the plane on which the light is deflected, by disposing the reflecting surface facing the direction of the center of rotation of the optical deflector, it is possible to make the light deflected in each direction by the optical deflector incident on the reflecting mirror at small angles of incidence. In particular, by forming the reflecting surface of the reflecting mirror in an arc shape, it is possible to simplify the design of the reflecting mirror.

In the case that the arc shape of the reflecting mirror has a radius equal to the distance from the reflecting mirror to the reflecting surface of the optical deflector, by making the center position of the arc shape of the reflecting mirror align with the center of rotation of the optical deflector, it becomes possible to make the angle of incidence of the light on the reflecting mirror at all positions substantially zero.

In the case that the reflecting surface of the reflecting mirror has a shape that is symmetrical to the incident optical axis of the plane on which the light is deflected, by disposing the center of rotation of the optical deflector on the incident optical axis of the reflecting mirror, it becomes possible to make the change in the angle of incidence to the reflecting mirror due to the rotation angle of the optical deflector equal on both sides of the optical axis.

In the case that the reflecting surface of the reflecting mirror has an axisymmetric shape along the direction perpendicular to the plane on which the light is deflected, and in the case that the axisymmetric shape is a straight line or an arc, and in the case that the axisymmetric shape is expressed by a function whose variables for the direction perpendicular to the plane on which the light is deflected includes secondary or higher-order terms, and in the case that the line serving as the reference for the axisymmetry is tilted with respect to the optical axis, it is possible to make the distance between the reflecting surface and the optical deflector different along the direction perpendicular to the plane on which the light is deflected. Therefore, the light path lengths of the light of each wavelength are respectively different, and thereby it is possible to compensate the wavelength dispersion.

In the case that the angle of incidence to the optical deflector in the plane on which the light is deflected is equal to or less than approximately 45°, the angle of incidence of the light to the optical deflector becomes small, and in particular, by the angle of incidence being made approximately 0°, the degradation of the reflectance can be prevented, and thereby it becomes possible to decrease the loss of the optical signal.

In the case that another optical element having a positive power is provided along the optical path from the optical deflector to the reflecting mirror, the light that has had angular dispersion imparted to each wavelength by the angular dispersive element is deflected in the directions over a predetermined angular range by the optical deflector. Then the range of motion of the focal point position of the light deflected by the optical deflector can be shortened by passing through the other optical element having a positive power. Therefore, it is possible to make the size of the reflecting mirror small.

In the case that the other optical element has a positive power only at the plane on which the light is deflected, the dispersion state of the light is maintained without the light being converged in the dispersion direction by the angular dispersive element, and thereby it is possible to shorten only the range of motion of the focal point position of the light deflected by the optical deflector.

In the case that the other optical element is an image-side telecentric optical element, the light incident on the other optical element from the optical deflector is made parallel to the optical axis, and then is output from the other optical element. Therefore, it becomes possible to dispose the focal point positions substantially linearly, and it becomes possible to structure the reflecting mirror so as to have a substantially flat reflecting surface. In addition, it is possible to reduce the cost because parts that are the same as those of the reflecting mirror are used. The type of reflecting mirror that is used does not have the deflector that deflects light discussed in the Description of the Related Art.

In the case that one optical deflector is a rotating mirror and the other optical element is an arcsine lens, and in the case that one optical deflector is a polygonal mirror and the other optical element is an fθ lens, a relationship is established wherein the focal point positions on the reflecting surface of the reflecting mirror can be easily derived from the angle deflected by the optical deflector. Therefore, it is possible to design the reflecting mirror easily.

In the dispersion compensator described above, when the angular dispersive element is structured using a diffraction grating, a prism, or an interferometer, in particular, a Fabry-Pérot interferometer or a Fabry-Pérot etalon, it becomes possible to obtain an angular dispersion that depends on the wavelength. In particular, by using a Fabry-Pérot interferometer or a Fabry-Pérot etalon as the angular dispersive element, it is possible to attain a large amount of angular dispersion depending on the wavelength, and this is effective.

In addition, because absorption in the optical transmission element is suppressed by using a light in the 1.2 to 1.7 μm wavelength band as the transmitted light, it is possible to carry out compensation of the wavelength dispersion by using a high intensity optical signal.

In addition, the dispersion compensation system comprises the dispersion compensator described above, a signal monitor that monitors the light emitted from the dispersion compensator and outputs a signal that includes dispersion data for the light, and a control apparatus that controls the deflection angle of the optical deflector so as to decrease the amount of dispersion based on the signal that includes dispersion data output from this signal monitor.

Thereby, the dispersion data for the light whose wavelength dispersion has been compensated by the dispersion compensator is output from the signal monitor, and the deflection angle of the optical deflector is controlled by the operation of the control apparatus based on this dispersion data. Therefore, the wavelength dispersion can be compensated each time if the amount of wavelength dispersion fluctuates due to other factors even in the case that the amount of wavelength dispersion is determined in a state wherein the length of the optical transmission element and the like has been determined, and thereby, the deflection angle of the optical deflector is determined so as to obtain appropriate compensation.

What is claimed is:

1. A dispersion compensator comprising:
an angular dispersive element that varies the angle at which the light, emitted from an optical transmission element through which the light is transmitted, is output depending on the wavelength of the light;
an optical element that condenses the light emitted from the angular dispersive element;
an optical deflector that deflects the light emitted from the optical element; and
a reflecting mirror that is disposed in proximity to the focal point position in an entire optical system and that has a reflecting surface whose shape along the direction perpendicular to the plane on which the light is deflected changes at least in the direction along the plane on which the light is deflected.

2. A dispersion compensator according to claim 1, wherein all angles of incidence of the light deflected by the optical deflector to the reflecting mirror are within a range equal to or greater than −5° and equal to or less than +5°.

3. A dispersion compensator according to claim 1, wherein the direction in which light is deflected by the optical deflector is perpendicular to the direction in which each wavelength is dispersed by the angular dispersive element.

4. A dispersion compensator according to claim 1, wherein the reflecting surface of the reflecting mirror is formed by a free-form surface having an asymmetrical shape with respect to an optical axis.

5. A dispersion compensator according to claim 1, wherein the reflective surface of the reflective mirror has a concave shape in the plane on which the light is deflected.

6. A dispersion compensator according to claim 5, wherein the reflective surface of the reflective mirror has an arc shape in the plane on which the light is deflected.

7. A dispersion compensator according to claim 6, wherein the arc shape of the reflecting surface has a radius equal to the distance from the reflecting mirror to a reflecting surface of the optical deflector.

8. A dispersion compensator according to claim 5, wherein the reflecting surface of the reflecting mirror has a shape that is symmetrical with respect to an incident optical axis in the plane on which the light is deflected.

9. A dispersion compensator according to claim 1, wherein the reflecting surface of the reflecting mirror has an axisymmetric shape along the direction perpendicular to the plane on which the light is deflected.

10. A dispersion compensator according to claim 9, wherein the axisymmetric shape is a straight line.

11. A dispersion compensator according to claim 9, wherein the axisymmetric shape is an arc.

12. A dispersion compensator according to claim 9, wherein the axisymmetric shape is expressed by a function wherein the variables for the direction perpendicular to the plane on which light is deflected includes secondary or higher-order terms.

13. A dispersion compensator according to claim 9, wherein an axis that serves as the reference for the axisymmetry is inclined with respect to the optical axis.

14. A dispersion compensator according to claim 1, wherein the angle of incidence of the optical deflector on the plane on which light is deflected is equal to or less than approximately 45°.

15. A dispersion compensator according to claim 1, wherein the angle of incidence of the optical deflector on the plane on which light is deflected is approximately 0°.

16. A dispersion compensator according to claim 1, further comprising another optical element that has a positive power on an optical path from the optical deflector to the reflecting mirror.

17. A dispersion compensator according to claim 16, wherein the another optical element has a positive power only in the plane on which the light is deflected.

18. A dispersion compensator according to claim 16, wherein the another optical element is an image-side telecentric optical element.

19. A dispersion compensator according to claim 16, wherein the optical deflector is a rotating mirror, and the another optical element is an arcsine lens.

20. A dispersion compensator according to claim 16, wherein the optical deflector is a polygonal mirror, and the another optical element is an fθ lens.

21. A dispersion compensator according to claim 1, wherein the angular dispersive element is formed by a diffraction grating.

22. A dispersion compensator according to claim 1, wherein the angular dispersive element is formed by a prism.

23. A dispersion compensator according to claim 1, wherein the angular dispersive element is formed by an interferometer.

24. A dispersion compensator according to claim 23, wherein the angular dispersive element is formed by a Fabry-Pérot interferometer.

25. A dispersion compensator according to claim 1, wherein the angular dispersive element is formed by a Fabry-Pérot etalon.

26. A dispersion compensator according to claim 1, wherein the transmitted light is light in the 1.2 to 1.7 μm wavelength band.

27. A dispersion compensator according to claim 1, wherein the cross-sectional shape of the reflecting surface of the reflecting mirror changes continuously in the direction in which light is deflected by the optical deflector.

28. A dispersion compensator according to claim 1, wherein the cross-sectional shape of the reflecting surface of the reflecting mirror changes discontinuously or step-wise in the direction in which light is deflected by the optical deflector.

29. A dispersion compensator according to claim 1, wherein the reflecting mirror is fixed and the optical deflector is structured so as to be able to rotate.

30. A dispersion compensator according to claim 16, the another optical element being a cylindrical lens, and
the optical element is another cylindrical lens having power only in the direction perpendicular to the direction in which the cylindrical lens has a positive power and having a focal point position at the same position as the focal point position of the cylindrical lens.

31. A dispersion compensating system comprising:
a dispersion compensator according to claim 1;
a signal monitor that monitors light output from the dispersion compensator and outputs a signal that includes dispersion data of the light; and
a control apparatus the controls the deflection angle of the optical deflector so as to decrease the amount of dispersion based on the signal that includes the dispersion data output from the signal monitor.

32. A dispersion compensator comprising:
angular dispersive means for varying the angle at which light, emitted from optical transmission means through which the light is transmitted, is output depending on the wavelength of the light;
condensing means for condensing the light emitted from the angular dispersive means;
optical deflecting means for deflecting the light emitted from the condensing means; and
reflecting means being disposed in proximity to the focal point position in an entire optical system and having a reflecting surface whose shape along the direction perpendicular to the plane on which the light is deflected changes at least in the direction along the plane on which the light is deflected.

33. A dispersion compensation method comprising the steps of:
varying the angle of emission of the light depending on the wavelength of the light transmitted through an optical transmission element and emitting the light whose angle of emission has been varied;
condensing the emitted light;
deflecting the condensed light; and
imparting optical path lengths that differ according to the reflection position in the direction perpendicular to the plane on which the condensed light is deflected in proximity to the focal point position of the deflected light, and reflecting the light to which different optical path lengths have been imparted.
